(19) United States
(12) Patent Application Publication
(10) Pub. No.: US 2014/0006193 A1
(43) Pub. Date: Jan. 2, 2014

(54) RETAIL EQUIPMENT

(71) Applicants: Rupert Holt, Watford (GB); Robin Brown, Watford (GB)

(72) Inventors: Rupert Holt, Watford (GB); Robin Brown, Watford (GB)

(73) Assignee: CAMELOT STRATEGIC SOLUTIONS LIMITED, Watford, Hertfordshire (GB)

(21) Appl. No.: 13/979,494

(22) PCT Filed: Jan. 12, 2012
(86) PCT No.: PCT/GB12/50062

§ 371 Date: Sep. 17, 2013

(30) Foreign Application Priority Data
Jan. 12, 2011 (GB) 1100489.2
Feb. 18, 2011 (GB) 1102879.2

(51) Int. Cl. G06Q 20/20

(52) U.S. Cl. CPC G06Q 20/202
USPC 705/20; 705/21

(57) ABSTRACT

According to one aspect, the present invention resides in an electronic transaction system for managing transactions related to items selected by a user, such as a checkout POS terminal for example. The system comprises a first transaction module arranged to manage transactions in respect of local items supplied within a retail environment; a data store arranged to store updatable data relating to remote items provided by a remote server; and a second transaction module arranged to access the updatable data to provide access to the remote items via the electronic transaction system.

### FIELD OF INVENTION

The present invention concerns improvements to electronic retail systems. In particular, the invention relates to electronic checkout equipment and processes used by retailers in their stores.

### BACKGROUND TO THE INVENTION

A typical retail environment, such as a shop or petrol station, includes one or more checkouts where customers may pay for their purchases. In most retail environments each checkout has electronic point-of-sale (POS) equipment which includes hardware which scans the barcode of each item chosen by a customer, retrieves the price of the scanned item from the retailer's pricing system and a cash register to enable customers to pay for their purchases. Checkouts may be staffed, wherein a cashier scans the barcode and assists customers with their purchases; or unstaffed, wherein customers scan the barcodes of the products themselves and pay for their purchases without help from a cashier. Such unstaffed checkouts are known as self-checkouts (SCOs).

Where a retailer has a number of stores, for example in a supermarket chain, the checkouts in each store of that chain may be networked over a telecommunications network, such as the Internet or a proprietary intranet, to a head office server to ensure consistency in relation to prices and services throughout a chain of stores. In a prior art system, the head office server contains pricing information for the products and services supplied by the retailer and transmits pricing information to individual stores over the network.

In addition to goods and services supplied by the retailer and included on its pricing system, customers are able to purchase third-party goods and services in a retail environment. For example, lottery services, mobile telephone top-up services, or utility payment and/or top-up services are typically offered as ancillary services in a retail environment.

In order to offer its goods or services, a third-party will typically install its own equipment or software in one or more stores of the retailer, which is solely dedicated to purchasing that third-party's goods or services. For example, a lottery provider may install its own lottery terminals in retail spaces, wherein each terminal communicates with a central lottery server independently of the supermarket's telecommunications network. Due to space constraints, such terminals are usually limited to one or two per store. This is inconvenient for customers wishing to buy lottery tickets because they must either buy those products separately to the rest of their shopping, or purchase their shopping at checkouts located at the lottery terminals.

In order to enable customers to purchase lottery products via any checkout in a store, International Patent Application Publication Nos. WO 02/068072 A2 and WO 2005/097281 A2 each provide in-store tokens that bear a barcode relating to a lottery game. In order to take part in a lottery, a customer selects a token relating to the lottery game they wish to play from an in-store display to one of the store's checkouts. The barcode on the token is scanned by the checkout equipment which is arranged to recognise the barcode on the token as a lottery purchase which is added to the bill for the customer's shopping, if necessary.

However, the systems disclosed in WO 02/068072 A2 and WO 2005/097281 A2 are limited in that customers cannot select their own numbers in draw-based lottery games. Instead, customers are obliged to play a random set of lottery numbers generated by the systems of WO 02/068072 A2 or WO 2005/097281 A2. In addition, if a store runs out of tokens the only option left to customers is to use a checkout comprising dedicated third-party equipment, if any such equipment is installed in that store. Accordingly, a further problem associated with these systems is that the tokens must be replaced when they are about to sell out. Furthermore, if there are any changes to the lottery games offered, or if the lottery provider intends to offer new lottery games, tokens relating to those offerings must be delivered to and displayed in-store, and the store's checkout system and pricing system must be updated in good time ahead of those changes. Depending on the changes taking place and the configuration of the retailer's pricing system, the third party must inform the retailer anywhere from a few days to a few weeks ahead of the price change.

International Patent Application Publication No. WO 03/104972 A1 discloses a lottery management system in which lottery tickets may be purchased through different channels, one of which is via retail checkout terminals. Each retail terminal includes dedicated third-party software for purchasing a lottery ticket.

International Patent Application Publication No. WO 2005/050470 A1 discloses a system in which POS equipment is arranged to display a lottery interface and a non-lottery interface. Similarly to WO 03/104972 A1, the POS equipment of WO 2005/050470 A1 has dedicated third-party software for purchasing a lottery ticket.

The dedicated third-party software disclosed in WO 2005/050470 A1 and WO 03/104972 A1 is either in the form of a “thick client” arrangement or a “thin client” arrangement.

In the “thick client” arrangement a complete lottery application resides on the electronic POS equipment. This requires a high level of integration between the lottery application and the POS equipment. Therefore, if there are any changes to the lottery games offered by the third-party, or the third party launches new lottery games, the POS equipment at each checkout that offers lottery games must be updated. Updating the POS equipment using this traditional approach is typically cumbersome and impractical to implement. Furthermore, modifying the POS equipment of each checkout requires a large amount of time and money in development, testing and installation for each new product or service that is added or changed. Particularly if a retailer's checkouts are not identical.

In the “thin client” arrangement a web browser resides on the POS equipment and accesses lottery applications relating to particular lottery games from a central server. However, this limits the use of a “thin client” to POS equipment that is compatible with a web browser. A further problem is that a web browser is not itself configurable with respect to the third-party goods and services that are offered via the checkout, and so no data is stored locally for easy retrieval and display to the customer. This means that any enquiries made by a customer as to the third-party services offered at a checkout is dependent on the bandwidth available on the retailer's network. Furthermore, the use of web technology exposes the central server to denial-of-service attacks. An associated problem is that web browser transactions may be spoofed which may result in fraudulent purchases of lottery products.

The present invention seeks to overcome or substantially mitigate the above mentioned problems and provide a secure and convenient method and apparatus for purchasing lottery tickets or other services via electronic POS equipment.

In addition, an aim of the invention is to provide methods and apparatus for purchasing third-party products via electronic POS equipment which are less cumbersome and easier to install on POS equipment.

### STATEMENTS OF INVENTION

According to a first aspect of the present invention, there is provided an electronic transaction system for managing transactions related to items selected by a user, the system comprising a first transaction module arranged to manage transactions in respect of local items supplied within a retail environment, a data store arranged to store updatable data relating to remote items provided by a remote server, and a second transaction module arranged to access the updatable data to provide access to the remote items via the electronic transaction system.

The present invention comprises an electronic transaction system that manages transactions of items selected by a user. For example, the system may relate to a checkout system within a retail store (a retail environment) comprising one or more checkouts (staffed checkouts, SCOs or kiosk checkouts) that are controlled by a server computer within the retail store.

The electronic transaction system of the present invention comprises a first transaction module that is used to manage transactions relating to local items supplied within the retail environment. In the above example, the first transaction module may comprise the existing POS equipment that is located within the checkout area. According to the present invention a data store is provided which stores information relating to remote items that are held remotely from the retail environment. In the above example, the remote items may be lottery tickets that are stored or generated at a lottery provider's remotely located server and the data within the data store may comprise data for use in connecting and interacting with the remote server and/or may comprise data relating to the remote items for display to a user in order to select a particular item. The present invention further provides a second transaction module that accesses and uses the updatable data within the data store to access the remote items on the remote server and/or provide an input means for selecting a remote item.

It is noted that the data store and second transaction module may be located within a POS terminal within the retail environment (e.g. within the POS terminal at each checkout). Alternatively, either or both of the data store and second transaction module may be located elsewhere within the local retail environment, e.g. on a server computer or other computer terminals within the local retail environment, and be in communication with the POS terminal via a communications network.

An advantage of the present invention is provided by having a transaction module arranged to access the updatable data to provide access to the remote items via the electronic transaction system. This transaction module (the second transaction module) may be located on standard POS equipment or elsewhere in the retail environment. The present invention therefore enables communication with the remote server to take place using the updatable data within the data store to define the communication between the electronic transaction system and the remote server. Since the data within the data store is updatable the system may be easily updated with details of new remote items (goods and/or services), and any associated display or input data, that may be selected by the user, or amendments to existing remote items. The access to the remote items may therefore be altered via an update process which does not need to modify any of the standard components within the POS equipment within the retail environment. For example, the invention enables additional services for remote items to be accessed via the electronic transaction from the remote server by updating the updatable data.

The updatable data within the data store may preferably be a set of configuration files that may be updated to handle new services, changing interfaces or network protocols, for example. Advantageously, the configuration files may be updatable to provide such new functionality to the electronic transaction system without the need to release new control software for the transaction module, thereby requiring minimal post-implementation support. Installing the invention is less labour-intensive than prior art integration methods and reduces the time required for development and testing when introducing a new service, or integration with a retailer's equipment.

Typically in prior art systems, content such as price updates is released to an implementation team who, in turn, update files located within the retail environment, and possibly set up new price codes on the retailer's in-store systems as required. The invention enables changes such as new products, pricing changes and branding to be updated seamlessly. The updatable data may be updated with date and/or time activated triggers without further interaction to ensure changes and updates are available when required. For example, the invention enables a new price increase for a lottery product to be implemented at the same time across all the retail environments in which it is available.

Embodiments of the present invention may allow it to be installed on standard POS equipment regardless of the equipment's configuration, make or model. This overcomes the problem of systems of the prior art which do not acknowledge that checkout equipment may vary across a retail chain or within a retail store.

In a preferred embodiment, the second transaction module may be in communication with the first transaction module. The second transaction module may comprise a remote server proxy arranged to communicate with the remote server, which may be a CTP proxy as described herein.

In a further embodiment of the invention, the data in the updatable data store may comprise display related data for display to a user in the retail environment in order to allow the selection of a remote item. The system may also comprise input means to enter data at a visual “front end” component for any remote item, such as for a service, product or game. Again, the input means and the display data are configurable by means of the updatable data. Therefore, the input means may provide a display for a multitude of services, products or games, and may be updated by remote updates from the remote server with minimal impact to the POS equipment. For example, a mobile top-up service may be added to the equipment for a checkout, or set of checkouts, on which lottery games are available. In this respect, the data store may comprise display related data and/or access related data that are/is updatable with newer version data.

The data in the data store may comprise access related data to allow the transaction system and/or the second transaction module to access a remote item for provision to the user in the retail environment. Furthermore, the electronic transaction system and/or the second transaction module may be arranged to download newer version data (of the remote item data held within the data store) from a remote data source which may be the remote server. Alternatively, the data may be updated with newer version data sideloaded from a data module in the retail environment. For example, updates could be downloaded from the remote server to a separate device such as a USB drive or DVD/CD and then copied across to the electronic transaction system in order to update the data within the data store.

Preferably, the data store contains at least one configuration file that defines data associated with one or more remote items. The at least one configuration file may include a master configuration file which controls the updating of the data in the data store. The at least one configuration file may be updateable. However, the master configuration file may be arranged so that it is not updated or not updatable. The master configuration file may contain parameters relating to the configuration of the second transaction module, and may be stored in the updatable data store, the second transaction module or elsewhere.

The at least one configuration file may include at least one subordinate configuration file which defines the parameters associated with one or more remote items. The at least one subordinate configuration file may be updatable. The at least one subordinate configuration file may be located on a server remotely located with respect to the electronic interaction system. The at least one subordinate configuration file may include at least one communications and/or protocol file that defines the parameters for communications between elements of the system. The at least one subordinate configuration file may include at least one service request control file that defines the structure of messages sent between elements of the system. The at least one subordinate configuration file may include at least one error file that provides a means of identifying errors and responding accordingly. Preferably, the at least one error file includes a list of error codes and a list of error messages which may be linked. The at least one subordinate configuration file may include at least one pricing file which indicates the prices of the remote items. The at least one subordinate configuration file may include at least one reference file for accessing information not available in the electronic transaction system. The at least one subordinate configuration file may include at least one file arranged to enable one or more subordinate configuration files to be modified, preferably by using the electronic transaction system.

In addition, the data may comprise updatable image data files for generating a GUI or branding associated with the remote items, for example.

Preferably, the electronic transaction system comprises a data entry module which may be arranged to access data stored in the data store. The data entry module may be located in the electronic transaction system, in the second transaction module or on a server remotely located to the electronic transaction system.

Preferably, the electronic transaction system may comprise a display, and the data entry module may be arranged to display a GUI on the display. The display may be arranged to display details of the local items and/or the remote items. The data entry module may be a data capture component as described herein.

In an alternative embodiment, the data entry module may be arranged to read a code from a code carrying device. In this embodiment, the data entry module does not utilise the display. Instead, data may be entered via a barcode which is scanned by a scanner wherein the code carrying device is a card. Alternatively, the code may be carried on a magnetic strip of a credit card style card, or the code may be carried on a near-field communication or contactless device such as a mobile telephone.

In a further alternative embodiment, the electronic transaction system may comprise input means for inputting data, wherein the input means may be a touch-screen display. The electronic transaction system may further comprise a printer for printing information relating to the local items and/or the remote items. The electronic transaction system may further comprise a cash register arranged to enable transactions for the local items and/or the remote items to be completed.

The electronic transaction system may be linked to a local server which comprises or is linked to a local item database which stores details associated with the local items.

Preferably, the second transaction module may be arranged to generate an initial update message, and may be arranged to send the initial update message to the remote server in order to update the data stored in the data store. The second transaction module may be arranged to generate a remote item request message using data stored in the updatable data store, and may be arranged to send the remote item request message to the remote server. The second transaction module may be arranged to receive a response update message in order to update the data stored in the data store. The second transaction module may be arranged to receive a remote item or remote item data from the remote server.

In a preferred embodiment, the first transaction module may be a POS application as described herein, the second transaction module may be a POS client as described herein and the updatable data store may be a proxy asset register as described herein.

The electronic transaction system may be incorporated on a standard POS terminal or may be distributed over a communications network.

According to a second aspect, the present invention resides in a combination of at least one electronic transaction system and a remote server, wherein the remote server is a depository for the remote items, or generates remote items “on the fly”, and is arranged to deliver one or more remote items to at least one electronic transaction system. The remote server may be linked to at least one electronic transaction system via a remote server gateway arranged to distribute the remote items to one or more electronic transaction systems. The combination may comprise one or more communication networks linking one or more of the components of the combination. One or more of the communication networks may be the Internet, and at least one of the communication networks may comprise one or more private wide-area networks. The remote server may be arranged to communicate with the second transaction module of at least one electronic transaction system.

According to a third aspect of the present invention there is provided a method of updating a transaction module for managing transactions of remote items obtained from a remote server, wherein the remote items are supplied via an electronic transaction system, the method comprising sending an initial update message from the transaction module to the remote server, wherein the update message contains details of data stored in an data store, comparing the details of the data stored in the data store with a data record indicating the remote items available via the electronic transaction system, and determining if the contents of the data store require updating, and downloading data from the remote server which comprise updates for the data store.

The method further preferably comprises receiving the data record from the remote server in a response update message. The downloading step preferably comprises sending an initial download message from the transaction module to the remote server, preferably wherein the initial download message contains details of the updates required by the data store, and preferably receiving a response download message from the remote server, wherein the response download message contains the updates. The updates may be downloaded in a ZIP file or other data-compression format, and may comprise configuration file updates and/or image data file updates.

The updates may preferably be extracted into a temporary folder located in the transaction module or the data store. The method may comprise updating the data stored in the updatable data store. The updating step may comprise modifying, deleting or replacing data stored in the updatable data store. The details of the response update message may be recorded on a master schedule. The master schedule may be stored on the electronic transaction system. The remote server may perform the comparing step. The transaction module may perform the comparing step. The data store may contain details of remote items obtainable from the remote server. The method may commence when the electronic transaction system is in a dormant state. The method may further comprise reinitialising the transaction module, which may be a first or second transaction module as described with respect to the first aspect of the invention.

According to a fourth aspect, the invention resides in a method of performing a transaction in which a remote item is obtained from a remote server via an electronic transaction system, the method comprising selecting a class of remote item from one or more classes of remote items, reading data associated with the selected class of remote item, wherein the data is stored in a data store, entering input data relating to one or more variables associated with the selected class of remote item into a data input means, sending the input data to the remote server in a remote item data message, receiving a remote item acknowledgement message from the remote server containing transaction data confirming that the remote item has been obtained. Preferably, the input data may be sent from a transaction module, for example a second transaction module, to the remote server in the remote item data message.

Preferably, the input data required by the method is defined by the data associated with the selected class of remote item. The item acknowledgement message preferably contains the remote item. The method may commence with initialisation of the electronic transaction system. The method may comprise assigning a unique ID to the transaction. The data input means may be a GUI displayed on a touch-screen. The remote item data message may be constructed by the data input means. The remote item data message may be transmitted from a remote server proxy to the remote server. The remote item data message may comprise a text-string, wherein the text-string may be in XML mark-up language.

In a further preferred embodiment, the method may comprise validating the remote item data message at the remote server, and the remote server may provide a remote item relating to the remote item data message in the remote item acknowledgement message. The remote item acknowledgement message may comprise a text-string, wherein the text-string may be in XML mark-up language.

In alternative embodiments, XML may be replaced with a plain text file, such as a comma-separated (CSV) file, JavaScript Object Notation (JSON) or Javascript, for example.

Preferably, the electronic transaction system may comprise a local transaction module arranged to manage and/or process transactions in respect of local items found within a local retail environment.

Preferably, the sending step comprises sending the remote item data message from a first transaction module to a second transaction module, as described in relation to the first aspect of the invention, or vice versa. The method further may comprise adding the remote item to transaction data of local items stored in the local transaction module. The method may further comprise printing a document in respect of the remote item.

According to a fifth aspect, the invention resides in a method of installing a transaction module which is arranged to manage transactions in respect of one or more remote items obtainable from a remote server, the method comprising loading the transaction module onto a electronic transaction system; and loading a data store onto the electronic transaction system, wherein the data store or the transaction module provides access to one or more remote items via the electronic transaction system.

The method of installation advantageously enables a transaction module (which equates to the “second transaction module” according to the first aspect of the invention) to be installed on an electronic transaction system which may include standard POS equipment with minimal, if any, modification of the system. The electronic transaction system may comprise a first transaction module for managing transactions of local items supplied within a retail environment. The data store may contain updatable data to provide access to the remote items. The method may further comprise loading a master file which is arranged to configure the second transaction module and/or the data store.

According to a sixth aspect the invention resides in a transaction arrangement for providing a retail transaction system access to one or more remote items provided by a remote server, the arrangement comprising a data store arranged to store updatable data relating to one or more remote items provided by the remote server, and a transaction module arranged to access the updatable data to provide the retail transaction system access to one or more remote items.

It is noted that the transaction module according to the sixth aspect of the present invention equates to the second transaction module described above in relation to the first aspect of the invention.

According to a seventh aspect, the invention resides in a data carrier containing instructions when executed on a computer to provide one or more of the methods or apparatus described herein.

One or more features described with respect to any aspect of the invention may be readily incorporated with one or more features of another aspect of the invention.

Furthermore, features described in alternative aspects may be equivalent. For example, the transaction module of the sixth aspect may be equivalent to the second transaction module described above.

### BRIEF DESCRIPTION OF THE DRAWINGS

Presently preferred embodiments of the present invention will be described, by way example only, with reference to the following drawings, in which:—

FIG. 1 is a schematic diagram of a known supermarket communication and transaction system;

FIG. 2 is a schematic diagram of a supermarket communication and transaction system according to the present invention;

FIG. 3 is a schematic diagram of checkout POS equipment according to the present invention;

FIG. 4 is a schematic diagram of a POS client and a central trading platform (CTP) according to the invention;

FIG. 5 is a schematic diagram of a CTP proxy according to the present invention;

FIG. 6 is a schematic diagram which illustrates a set of asset files and their relationship with the CTP proxy;

FIG. 7a is a message flow diagram illustrating a method of purchasing a lottery ticket according to a first embodiment of the present invention;

FIG. 7b shows a lottery play-slip displayed on a graphical user interface (GUI) in accordance with the invention;

FIG. 7c is a diagram that illustrates the steps taken by the CTP proxy when a message is sent from the POS equipment to the CTP;

FIG. 8 is a message flow diagram illustrating a method of purchasing a lottery ticket according to a second embodiment of the present invention;

FIG. 9 is a message flow diagram illustrating a method of voiding a lottery transaction according to the present invention;

FIG. 10 is a message flow diagram illustrating a method of cancelling a lottery ticket according to the present invention; and

FIG. 11 is a message flow diagram illustrating a method of updating the present invention to add or modify services provided by the invention.

### DETAILED DESCRIPTION

The invention will now be described with reference to purchasing remote item within a retail environment. Specifically, a lottery ticket from within a supermarket. However, it is clear that the invention is not limited to the purchase of lottery tickets and may be used to purchase other goods or services in other retail environments.

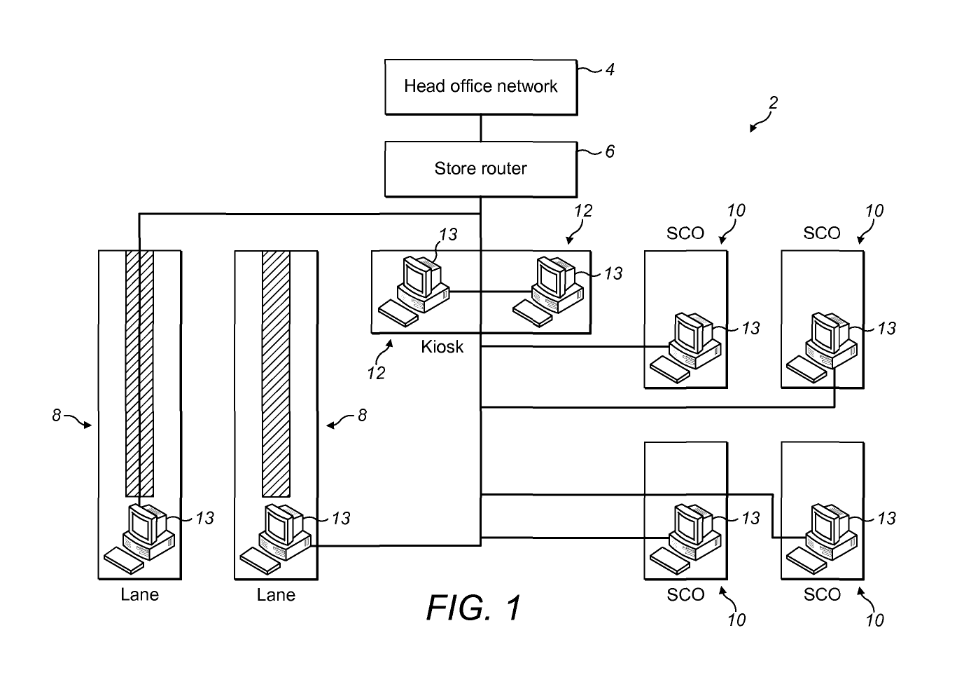

FIG. 1 illustrates a supermarket communication and transaction system 2 according to the prior art. The system 2 comprises a head office network 4 that communicates with a store router 6 which manages communication between the head office network 4 and one or more branches of a supermarket chain. The store router 6 communicates with checkouts 8, 10, 12 in one or more stores of the supermarket chain. For clarity, FIG. 1 shows a store router 6 and a network of checkouts 8, 10, 12 associated with a single store in the supermarket chain. The network of checkouts 8, 10, 12 include staffed lane-style checkouts 8, self-checkouts (SCOs) 10 and kiosk checkouts 12 such as those found in a cigarette kiosk of a supermarket. Each prior art checkout 8, 10, 12 has POS equipment 13, the components and functions of which are discussed further below.

Since the checkout network illustrated in FIG. 1 is a closed system, any third-parties that provide goods and services in the supermarket must install their own terminals or software applications in the supermarket, and provide access to the third-party's network.

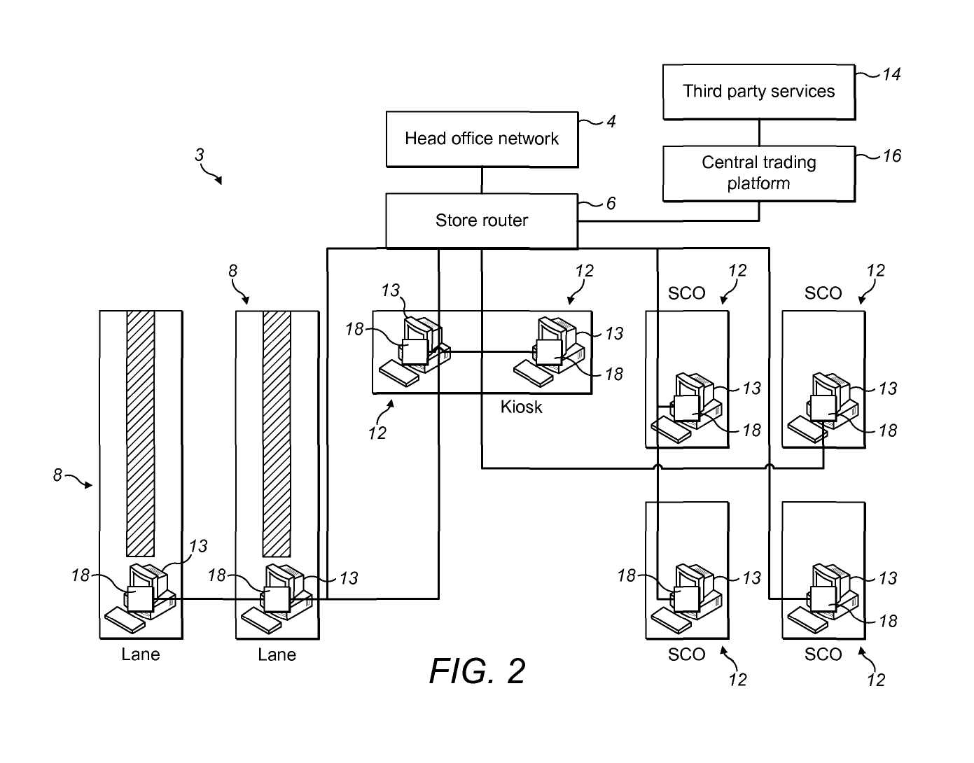

FIG. 2 illustrates a supermarket communication and transaction system 3 according to the present invention. The supermarket communication and transaction system 3 shown in FIG. 2 is similar to that shown in FIG. 1, with the differences between the systems described below. Components common to the systems of FIGS. 1 and 2 retain the reference numerals given in FIG. 1.

A third-party services server 14 is maintained by a third party and contains details of the goods and/or services provided by a third party. In the presently described embodiment of the invention the third-party is a lottery provider and the third-party services server 14 contains details of lottery games and products available to the public. The third-party services server 14 communicates with a central trading platform (CTP) 16. The CTP 16 provides a gateway for the third-party services server 14 to enable communication with the store router 6. The POS equipment 13 at each checkout 8, 10, 12 includes further software according to the invention referred to generally as the POS client 18.

Each checkout 8, 10, 12, and therefore each POS client 18, is linked to the store router 6 and the head office network 4 via a first telecommunications network which is a private wide-area network. The store router 6 is linked to the CTP 16 via a second telecommunications network, which may be a private wide-area network or the Internet.

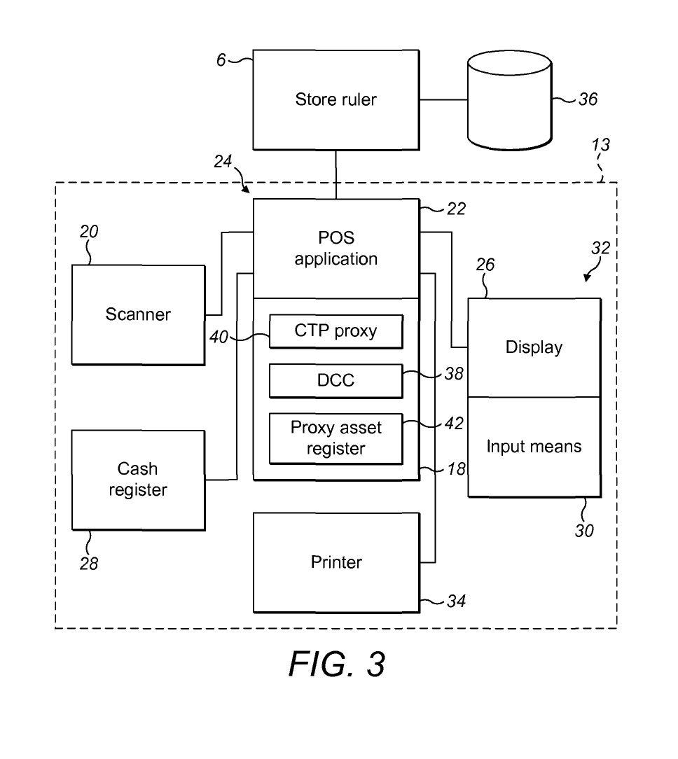

FIG. 3 is a schematic representation of the POS equipment 13 found at any one of the checkouts 8, 10, 12. Any checkout according to the invention—whether it is a staffed lane-style checkout 8, an SCO 10 or a kiosk checkout 12—will include one or more of the components shown in FIG. 3.

The POS equipment 13 comprises a scanner 20 arranged to scan the barcodes of products found in the supermarket and to transmit a scanned barcode to a POS application 22 which may be a first transaction module. The POS application 22 is a standard application supplied with and pre-installed on the POS terminal 24. The POS application 22 is responsible for providing the checkout functions of the POS equipment 13. For example, the POS application 22 receives and processes barcodes from the scanner 20 and obtains pricing information associated with each barcode.

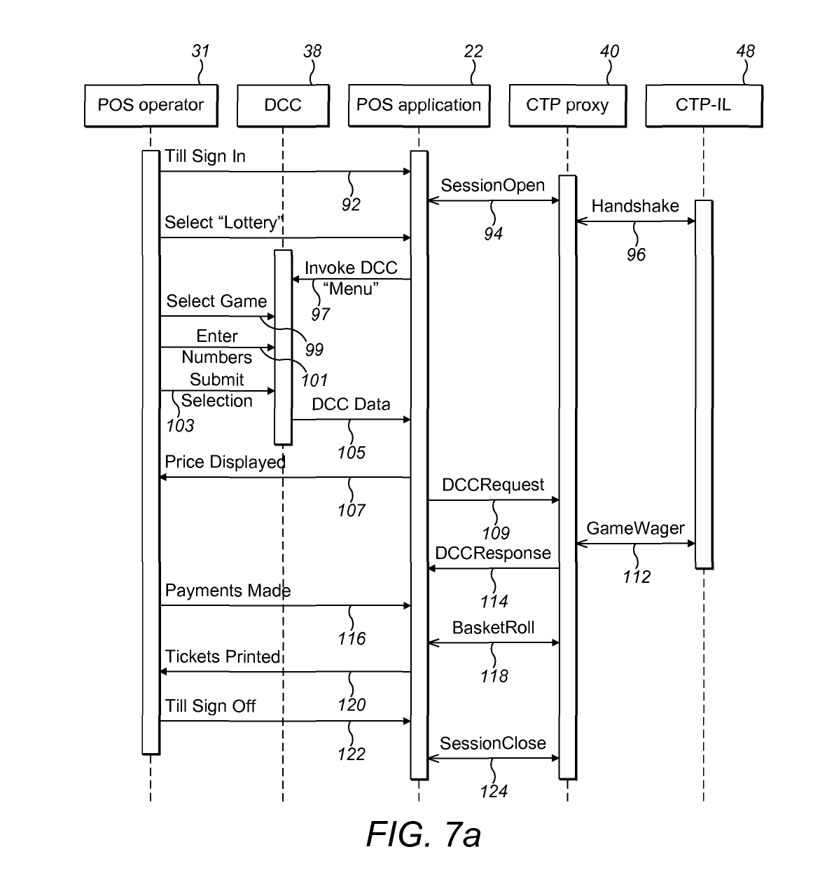

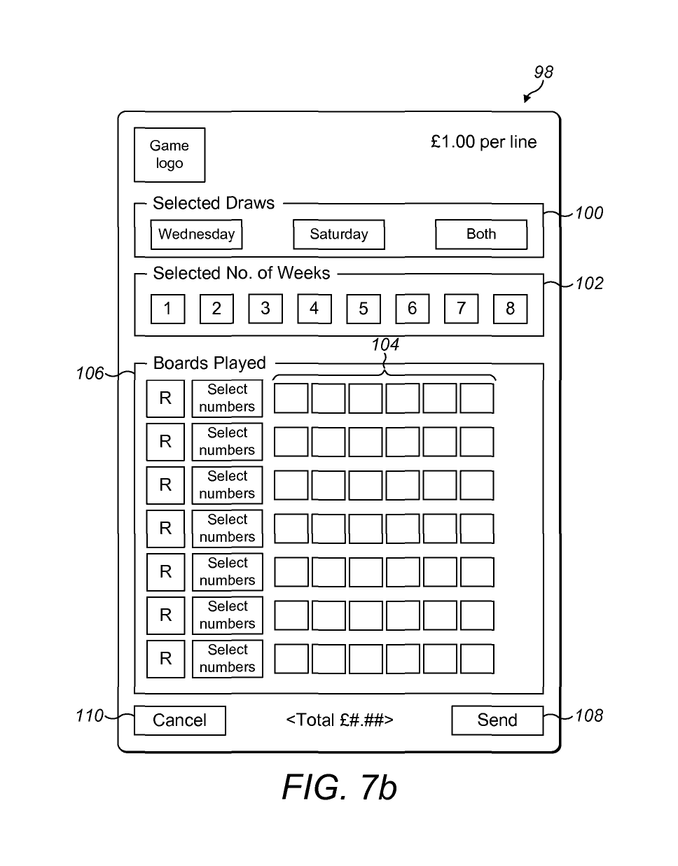

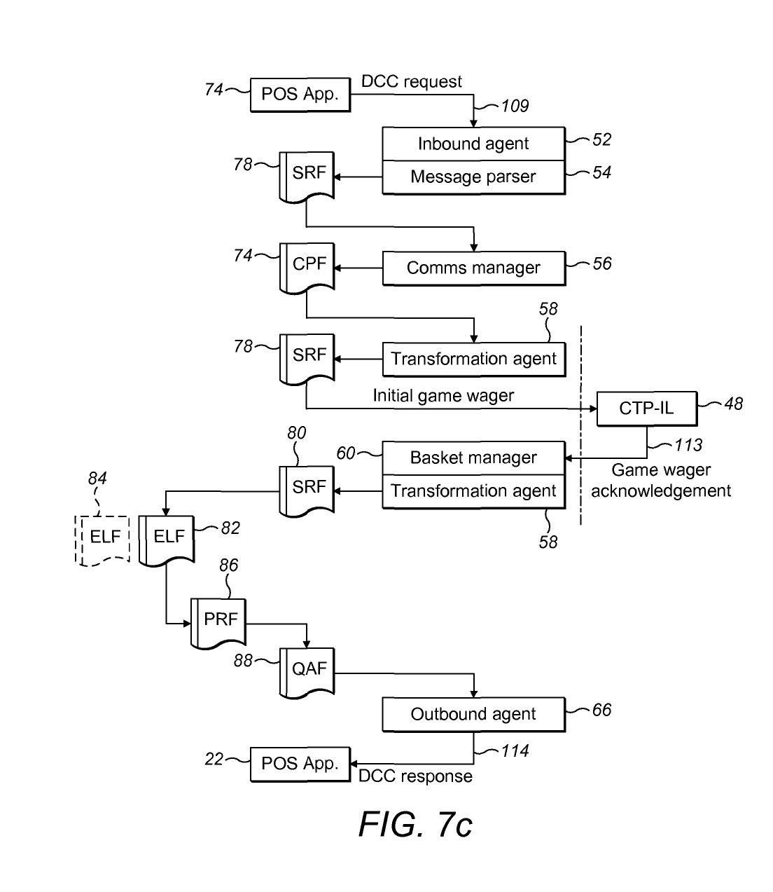

A display 26 is arranged to displays information associated with scanned products, for example, each product's individual price and the total cost of all the products chosen by a customer. A customer pays for their purchases using a cash register 28 which includes an electronic funds transfer (EFT) device (not shown). The POS equipment 13 also includes input means 30 to enable a POS operator 31 (shown in FIG. 7a), i.e. a cashier in the case of a staffed checkout 8, 12 or a customer in the case of a SCO 10, to enter data into the POS terminal 24. The input means 30 may be a keyboard, voice recognition device or the electronic funds transfer (EFT) device. In the present embodiment, the input means 30 is incorporated with the display 26 as a touch-screen 32. The POS application 22 is arranged to process commands inputted via the touch-screen 32 and displaying buttons on the touch-screen 32.

The store router 6 is linked to a price database 36 which stores the barcodes of each of the products sold in the supermarket. The price of each product and any discount associated with the product are stored against that product's associated barcode in the price database 36. On receiving a barcode from the scanner 20 the POS application 22 obtains information associated with each barcode from the price database 36. The details of the scanned products are typically stored in a POS application basket (not shown). The POS application 22 calculates the total price of the products selected by a customer and applies any discounts where necessary.

A printer 34 is arranged to print a receipt for the customer's shopping, and which is also arranged to print a lottery ticket in accordance with embodiments of the present invention.

The POS client 18 includes, a data capture component (DCC) 38 software component, a central trading platform proxy (CTP proxy) 40 software component which may be a second transaction module and a proxy asset register 42 which may be a data store. In an alternative embodiment, one or more of the DCC 38, CTP proxy 40 or the proxy asset register 42 may be installed on the store router 6, the head office server 4 or elsewhere, and networked to one or more POS terminals 24. The POS client 18 and the DCC 38, CTP proxy 40 and proxy asset register 42 are arranged to communicate and run in conjunction with the existing POS application 22 on the POS terminal 24.

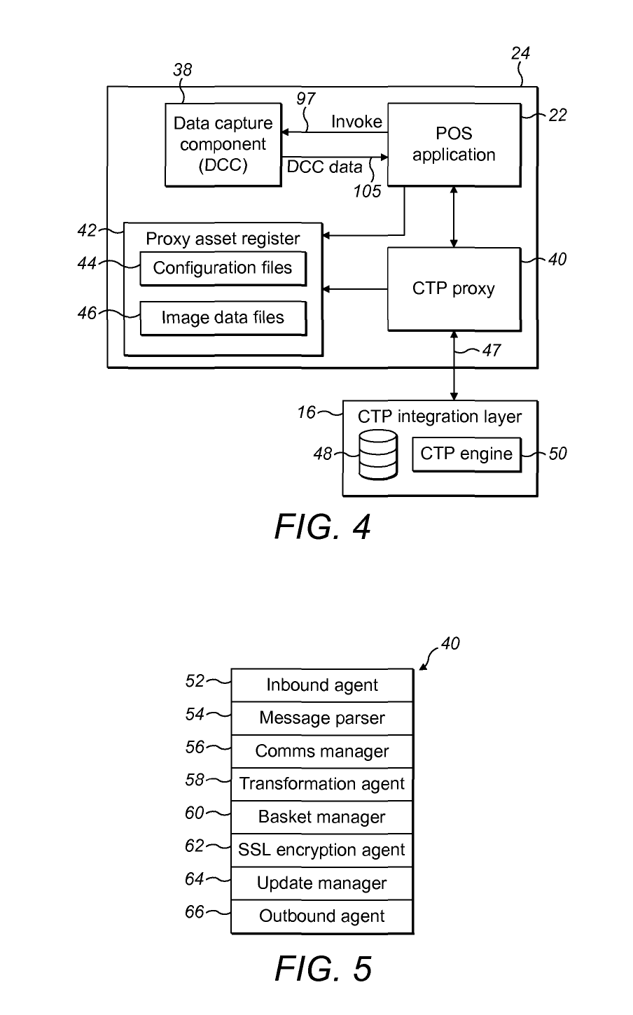

The components of the POS terminal 24 and their interaction are shown in more detail in FIG. 4. The proxy asset register 42 contains an updatable data store that stores data in the form of a set of updatable asset files, namely configuration files 44 and image data files 46 associated with one or more lottery games, wherein the configuration files 44 and image data files 46 are stored within the proxy asset register 42. The configuration files 44 define characteristics for each lottery game offered via the POS equipment 13. The configuration files 44 define the data that must be entered by a customer in order to purchase a ticket for a lottery game via the POS equipment 13. The image data files 46 ensure that each lottery game is presented on the display 26 of the POS equipment 13 in harmony with that game's branding.

In addition, the POS terminal 24 is in communication with the CTP 16 which comprises a CTP Integration Layer (CTP-IL) 48 and a CTP Engine (CTP-E) 50, via the CTP proxy 40. The store router 6 is located between the POS terminal 24 and the CTP 16, indicated by line 47, but is omitted from FIG. 4 to improve its clarity. Lottery transactions are sent from the POS client 18 at each checkout to the CTP-IL 48. The CTP-IL 48 routes data to and from the systems of the lottery provider, which may include the third-party services server 14, that are necessary to service the lottery purchase and ensures that an appropriate response is delivered that is compatible with the POS client 18. The CTP-E 50 processes communications received by the CTP-IL 48 and performs appropriate actions on the CTP 16. For example the CTP-E 50 logs lottery purchases against lottery games and communicates such information to the CTP-IL 48.

The POS application 22 is configured to communicate with the CTP proxy 40, DCC 38 and proxy asset register 42. Alternatively, the POS application 22 may have a mode of operation in which it operates in conjunction with the POS client 18, or modified to operate in conjunction with the POS client 18.

The CTP proxy 40 is effectively an extension of the CTP 16 within the POS terminal 24 and supplements the preinstalled POS application 22. The CTP proxy 40 manages communications between the POS client 18 and the CTP-IL 48. The CTP-IL 48 is the component of the CTP 16 which enables communication between the CTP 16 and the POS client 18.

The CTP proxy 40 provides a secure telecommunications channel between the POS terminal 24 and the CTP 16, so that a lottery purchase made on the POS equipment 13 is secure. In addition, the CTP proxy 40 accesses the set of updatable asset files, which include the configuration files 44 and data image files 46 stored in the proxy asset register 42. The CTP proxy 40 also manages changes and updates to the asset files.

The CTP proxy 40 provides secure communications by applying authentication credentials to messages transmitted from the CTP proxy 40 to the CTP-IL 48. For example, Secure Sockets Layer (SSL) cryptography may be applied to outgoing messages from the CTP proxy 40 before those messages are encrypted and compressed.

FIG. 5 illustrates the components of the CTP proxy 40 which include an inbound agent 52 which is arranged to monitor and manage all inbound messages to the CTP proxy 40. A message parser 54 which is arranged to validate the format of any inbound message. In this specific embodiment of the invention the message parser 54 is an XML parser with XSLT functionality. A communications manager 56 is arranged to manage connectivity and protocols for each external connection request, including anomaly control and timeout management. A transformation agent 58 is arranged to ensure that any message sent from the CTP proxy 40 complies with the requirements of the CTP 16. A basket manager 60 is arranged to manage a CTP proxy basket for the lottery purchase in harmony with the POS application 22 basket, including printing receipts. An SSL encryption agent 62 is arranged to manage security and encryption for messages between the CTP proxy 40 and the CTP-IL 48. An update manager 64 is arranged to manage updates and downloads of new lottery games in conjunction with an associated control file. An outbound agent 66 is arranged to validate the format of any outbound messages.

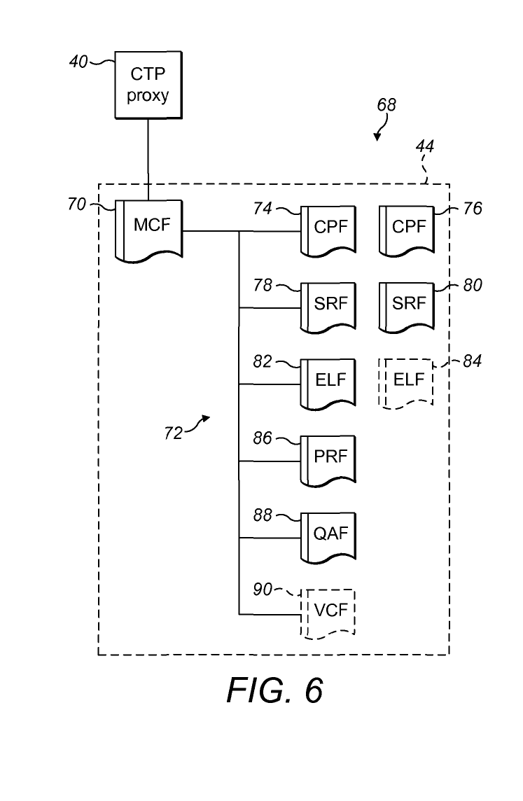

A set of configuration files 44 are stored in the proxy asset register 42. FIG. 6 illustrates the set of configuration files 44 and their hierarchy with respect to the CTP proxy 40. The configuration files 44 are used for each message sent between the CTP proxy 40 and the CTP-IL 48 to ensure that each message is correctly configured.

A master configuration file (MCF) 70 controls the functionality of the CTP proxy 40 and controls the subordinate configuration files 72. The MCF 70 drives all the functionality required by the CTP proxy 40. The MCF 70 is the only configuration file that is not modified by updates downloaded from the CTP-IL 48. In an alternative embodiment, the MCF 70 only may be installed in each POS client 18 in a supermarket store with the remaining configuration files stored on a shared file server, such as the store router 6, and accessed by each POS client 18.

Subordinate to the MCF 70 is a first communications/protocol file (CPF) 74 and a second communications/protocol file (CPF) 76 which define the parameters for first and second communications protocols. The first CPF 74 defines protocols for a first telecommunications standard—for example, the standard used for communication between the CTP proxy 40 and the CTP-IL 48, and the second CPF 76 defines protocols for a second telecommunications standard—for example communications between the CTP proxy 40 and the POS application 22.

A first service request control file (SRF) 78 defines the parameters for any first class of message and a second service request control file (SRF) 80 defines the parameters for any second class of message. For example, the first SRF 78 may define a SessionOpen message sequence or a DCCRequest message; and the second SRF 80 may define a Handshake message sequence or a GameWager message sequence, which are both described below.

A primary error file (ELF) 82 defines errors and error messages associated with communications between the CTP proxy 40 and the CTP-IL 48. It also contains codes associated with voiding and cancelling lottery tickets. A secondary error file (ELF) 84 provides the ability to define errors and associated error messages locally, and to define languages locally.

Each error response, whether it originates from communications between the CTP proxy 40 and the CTP-IL 48, or locally to the POS equipment 13, contains an error code. Each ELF 82, 84 contains a list of error codes. The error response error code is compared with the lists of error codes and an appropriate response is generated by the CTP proxy 40, which may be a warning shown on the display 26.

A pricing file (PRF) 86 lists the prices of the various lottery games offered via the POS equipment 13 at the checkout 8, 10, 12.

A question and answer parameter file (QAF) 88 is a reference file of a list of parameters or variables which may be required on an ad-hoc basis. For example, the POS Proxy 40, DCC 38, proxy asset register 42 or other component installed on the POS equipment 13 may require access to parameters or variables not stored on the POS electronic equipment 13. The QAF 88 is provided and updated remotely by the CTP 16 to provide a simple repository for these ancillary variables and parameters.

A variation control file (VCF) 90 provides the ability to modify locally on the POS equipment 13 one or more of the lottery games provided via that POS equipment 13.

A method of purchasing a ticket for a lottery draw using the present invention is now described with reference to FIG. 7a.

At step 92 the electronic POS equipment 13 at each checkout 8, 10, 12 is initialised a by the POS operator 31. This initiates a SessionOpen message sequence 94 in which an initial SessionOpen message is sent from the POS application 22 to the CTP proxy 40, which is acknowledged by a response SessionOpen message.

On receipt of the initial SessionOpen message the CTP proxy 40 opens a new session which is assigned a unique ID (not shown). A session is the time period between initialisation of the POS equipment 13, usually at the start of the working day, and turning off the POS equipment 13, usually at the end of the working day. The session ID is used to identify the session in messages sent to and from the CTP 16.

The CTP proxy 40 also opens a CTP proxy basket and assigns it a unique basket ID on receipt of the initial SessionOpen message. The unique basket ID allows the lottery transaction to be monitored as it progresses through the transaction process. The CTP proxy basket works in conjunction with the POS application 22, and the POS application basket if necessary, in which the details of the customer's other shopping is stored.

The session ID and basket ID enable a particular lottery transaction to be identified by the POS application 22, DCC 38, CTP proxy 40, CTP-IL 48 and any other elements of the system 3. For example, if the POS operator 31 signs out of the checkout 8, 10, 12 before the lottery purchase is completed, or if the POS application 22 crashes and restarts, the loss of the session will indicate to the CTP proxy 40 that the POS equipment 13 is no longer aware of the current session, and it shall automatically void any transactions within the current basket.

Only one session may be open at any one time on a CTP proxy 40, and only one active basket may be open within a session. Therefore, a session also protects against other types of anomaly, for example, it prevents two baskets running on the same POS equipment 13 at the same time.

Once a session and a CTP proxy basket have been set up, the CTP proxy 40 initiates a Handshake message sequence 96 with the CTP-IL 48 to alert the CTP 16 to the possibility of a lottery purchase. An initial Handshake message is sent from the CTP proxy 40 to the CTP-IL 48 which includes the session ID and the CTP proxy basket ID. The CTP-IL 48 then sends a Handshake response to the CTP proxy 40 confirming that the initial handshake message has been received and acted upon.

The POS application 22 communicates with the CTP proxy 40 using structured messages encapsulated in Simple Object Access Protocol (SOAP) version 1.1 format and delivered using HTTP on an internal TCP/IP socket.

During the checkout procedure, one or more lottery icons are displayed on the touch-screen 32 of the POS equipment 13. Each lottery icon is associated with a different lottery game offered via the POS equipment 13. The customer selects the lottery game they wish to play and presses the button relating to that game. In an alternative embodiment, the checkout may be a staffed checkout 8, 12, in which case the cashier presses the appropriate icon if the customer requests a lottery ticket.

On activation of the icon the POS application 22 invokes the DCC 38 to generate a menu at step 97 from which to select a lottery game at step 99. The DCC 38 reads the configuration files 44 associated with the selected lottery games from the proxy asset register 42, and uses the image data files 46 to display an electronic lottery play-slip 98 associated with that game. In the currently described embodiment, the lottery game is a traditional “lotto” game, the associated GUI of which is shown in FIG. 7b. However, the appearance of the GUI may be altered to reflect the lottery game in question or the fields may be displayed in a hierarchy of menus and screens if desired.

In the present embodiment, the DCC 38 is installed on the POS terminal 24 as part of the POS client 18 as a Microsoft Windows DLL file compatible with .NET Framework 2.0. Installation of the DLL file onto the POS terminal 24 as part of the POS client 18 is required only once when the DCC 38 is installed on the electronic POS equipment 13. Therefore, any subsequent lottery game changes will not require additional modification of the electronic POS equipment 13.

Accordingly, the GUI is rendered by a Windows browser control that is embedded into the DCC 38 and displayed in a window on the display 26. The POS application 22 controls where the GUI is displayed and its size. The GUI is defined in a standard language for web pages, such as HTML, CSS or JavaScript, which ensures that any compatibility issues with the POS equipment 13 on which the DCC 38 runs are kept to a minimum. The GUI is also configured to enable an administrator to generate reports on usage.

Using the GUI, the POS operator 31 then selects to play the Wednesday or Saturday draw, or both, in a “Selected Draws” area 100; selects the number of weeks to be played in a “Selected No. of Weeks” area 102; at step 101 the customer enters the numbers to be played in six lottery number fields 104 in a “Boards Played” area 106, or a random set of numbers is generated by selecting an “R” icon in the “Boards Played” area 106; and presses a “Send” button 108 to confirm these details and submit their selection, or presses a “Cancel” button 110 to cancel the lottery purchase and close the GUI.

Activation of the “Send” button 108 at step 103 causes the DCC 38 to build a dynamic XML string, which includes details of the lottery game selected and the data selected by the customer. The XML string is sent in a DCC data message 105 to the POS application 22. Other information may be conveyed in the DCC data message 105 to the CTP proxy 40.

Although the current embodiment of the invention is described in relation to purchasing a lottery ticket, it is to be understood that when using the invention to purchase other goods or services, the XML string will include data relevant to those good or services. For example, for the payment of a utility bill, the XML string may include account details, debit/credit card numbers and a payment amount. For mobile telephone top-up payment the XML string may include debit/credit card numbers, payment amount, mobile telephone number, mobile telephone network details. It is clear that the XML string may contain numerous varieties of data.

The POS application 22 extracts the details of the lottery purchase from the DCC data message 105, retrieves the price from the PRF 86 and displays the price on the display 26 of the POS equipment 13 at Step 107 in the same way as it does for products purchased from the supermarket.

The POS application 22 does not process any of the information entered into the DCC 38 via the GUI. Rather, the POS application 22 forwards the data associated with the lottery purchase to the CTP proxy 40 in a DCC request message 109, in which the data associated with the purchase is in XML format.

Operation of the CTP proxy 40 and the configuration files 44 is described in detail with reference of FIG. 7c. The DCC request message 109 is received at the inbound agent 52 which then passes the DCC request message 109 on to the message parser 54 and communications manager 56 which compare the DCC request message 109 with the first SRF 78 and the first CPF 76 respectively to confirm that the DCC request message 109 is a valid DCC request message 109.

After the DCC request message 109 has been validated, the DCC request message 109 is forwarded to the transformation agent 58 which transforms the DCC request message 109 into an initial GameWager message 111 of a GameWager message sequence 112. To ensure that the form of the initial GameWager message 111 is in a form acceptable to the CTP-IL 48 the transformation agent 58 refers to the second SRF 80. The initial GameWager message 111 carries the XML information contained in the DCC request message 109.

The initial GameWager message 111 is then forwarded to the CTP-IL 48 which then logs the lottery transaction on the CTP 16. Upon successful logging at the CTP 16, a GameWager acknowledgement message 113 is returned back to the CTP proxy 40 from the CTP-IL 48 as part of the GameWager message sequence 112 together with formatted ticket data to enable the printing of a lottery ticket. The GameWager acknowledgement message 113 contains printing data in an XML mark-up string that defines how the lottery ticket should appear when printed on the printer.

Receipt of the GameWager acknowledgement message 113 confirms to the CTP proxy 40 that the lottery purchase has been successfully logged on the CTP 16 and the lottery purchase is added to the CTP proxy basket by the basket manager 60. The transformation agent 58 verifies the GameWager acknowledgement message 113 using the second SRF 80.

The GameWager acknowledgement message 113 is also compared with the primary ELF 82 and secondary ELF 84 for any error codes, the PRF 86 for any price anomalies and the QAF 88 for any further anomalies. The outbound agent 66 of the CTP proxy 40 then sends a DCC response message 114 to the POS application 22 which adds the lottery purchase to the list of items stored in the POS basket to be purchased by the customer.

The skilled person will readily understand that the steps illustrated in FIG. 7c and described above apply to other messages sent between the POS application 22, CTP proxy 40 and the CTP-IL 48 described herein.

The customer then pays for their shopping at step 116, which includes the lottery purchase, in the normal way at the POS application 22. In the case of the lottery purchase described herein, the lottery ticket information contained in the GameWager acknowledgement message 113 is stored in the CTP proxy basket until the POS application 22 receives confirmation that the payment has been made at step 116.

On receipt of confirmation of payment the POS application 22 initiates a BasketRoll message sequence 118. An initial BasketRoll message is sent to the CTP proxy 40 which confirms to the CTP proxy 40 that the customer has paid for the lottery ticket. The CTP proxy 40 then sends the XML data contained in the GameWager acknowledgement message 113 to the POS application 22 in a further BasketRoll message, and empties the CTP proxy basket. The POS application 22 parses the XML data, if necessary, to create a document that is formatted for printing on the printer 34. The data is then sent to the printer 34 by the POS application 22, which prints the lottery ticket at step 120. If desired, the lottery ticket is printed as part of the retailer-controlled customer receipt. There is no need for the supermarket to modify the printed output or to record ticket information since the data is in XML format.

As part of the BasketRoll message sequence 118 the POS basket is emptied and made ready for the next transaction.

After the ticket has been printed the transaction involving that customer is finished. The POS equipment 13 may then be uninitialized by the POS operator 31 at step 122. After which the POS application 22 initiates a SessionClose message sequence 124 with the CTP proxy 40 to close the current session. At that point the POS equipment 13 is dormant.

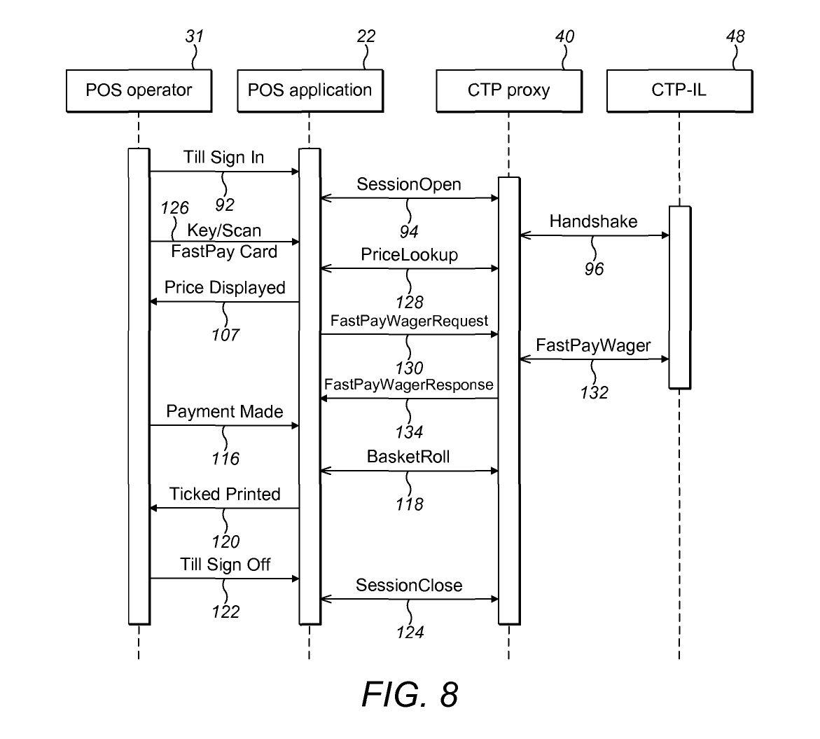

In an alternative embodiment of the invention, rather than entering the details of the lottery game they wish to play into the GUI generated by the DCC 38, a customer is issued with an identification card, referred to herein as a “FastPay Card”, on which is printed a barcode that identifies the customer, the lottery game and lottery numbers that the customer wishes to play. A method of operation of the second embodiment of the invention is described with reference to FIG. 8.

The method begins with initialisation of the POS equipment at step 92, the SessionOpen message sequence 94 and the Handshake message sequence 96 as described above for the first embodiment of the invention. The POS operator 31 selects a FastPay option displayed on the display 26. This instructs the POS application 22 to forward the next scanned code to the CTP proxy 40 which determines the type of lottery product being requested from the PRF 86. At step 126 the FastPay card is scanned using the scanner 20, or in an alternative embodiment, a corresponding code is manually entered using the input means 30. The barcode is sent to the CTP proxy 40 in an initial PriceLookup message of a PriceLookup message sequence 128. The CTP proxy 40 identifies the game that the customer wishes to play from the PRF 86, which or how many draws to play, the number of weeks to be played, the numbers to be played or whether a random selection of lottery numbers is required. Further information may be obtained from the CTP 16 based on information stored against that barcode.

The CTP proxy 40 returns the corresponding price and data for that barcode to the POS application 22 in an XML format in a further PriceLookup message of the PriceLookup message sequence 128. The data is displayed on the display 26 of the POS equipment 13. If the customer is satisfied they confirm the purchase by pressing an appropriate icon displayed on the display 26.

Upon confirmation of the lottery purchase, the POS application 22 sends a FastPayWagerRequest message 130 to the CTP proxy 40 with the details for that lottery purchase. The FastPayWagerRequest message 130 is validated by the CTP proxy 40 similarly to as described for FIG. 7c and then passed to the CTP-IL 48 for processing on the CTP 16 in an initial message of FastPayWager message sequence 132. A further message in the FastPayWager message sequence 132 is received back from the CTP-IL 48 indicating that the wager has been successfully placed, and includes formatted ticket data in XML format. This data is forwarded in a FastPayWagerReseponse message 134 sent from the CTP Proxy44 to the POS Application 22.

The customer then at step 116 pays for the lottery purchase and the method follows the steps set out in the first embodiment above. Namely, a BasketRoll message sequence 118 is performed, at step 120 the lottery ticket is printed out, along with the retailer-controlled customer receipt, and at step 122 the POS operator 31 ends the session by signing out of the POS equipment 13 which initiates a SessionClose message sequence 124 with the CTP proxy 40, indicating that the POS equipment 13 is dormant.

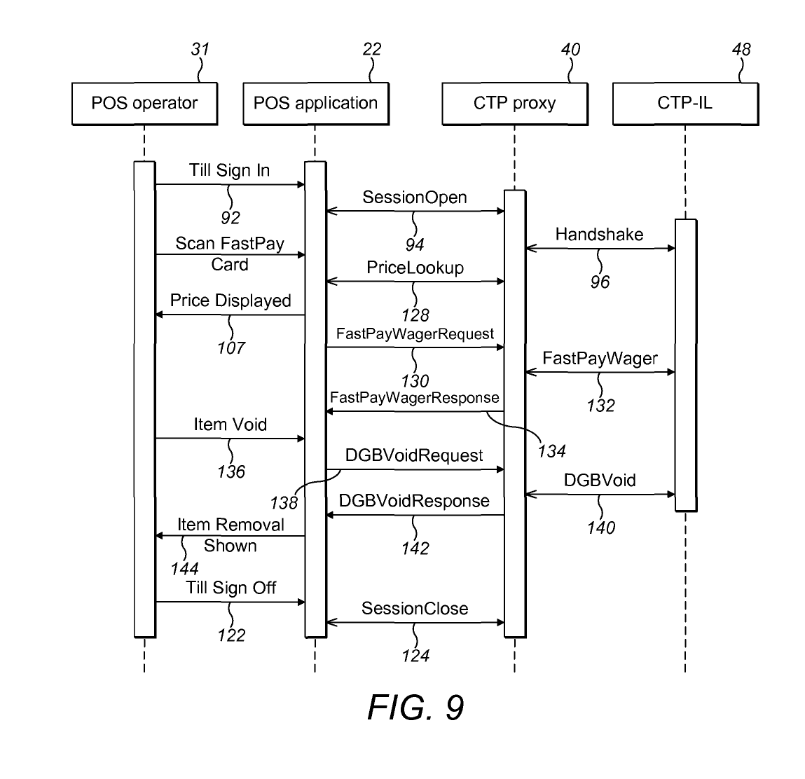

It may be necessary to void a lottery ticket before it is printed. For example, if a customer changes their mind in respect of entering a lottery. FIG. 9 illustrates a message flow similar to that shown in FIG. 8 for the second embodiment of the invention in which the lottery purchase is cancelled.

The message flow of FIG. 9 is similar to that shown in FIG. 8, until after the FastPayWagerResponse message 134 is sent from the CTP proxy to the POS application 22. At that point at step 136 the POS operator 31 presses a “Void” icon displayed on the display 26 of the POS equipment 13. The POS application 22 then sends a DBGVoidRequest message 138 to the CTP proxy 40, which includes the session ID and the CTP proxy basket ID. The DBGVoidRequest message 138 contains the appropriate error codes obtained from the primary ELF 82 and secondary ELF 84.

The DBGVoidRequest message 138 is forwarded to the CTP-IL 48 in an initial message of a DGBVoid message sequence 140. The initial message of the DGBVoid message sequence 140 contains the session ID and the CTP proxy basket ID for processing on the CTP 16. If the session ID and the CTP proxy basket ID match those held on the CTP 16 a response message is sent from the CTP-IL 48 to the CTP proxy 40 in the DGBVoid message sequence 140 validating the voiding of the ticket. The CTP proxy 40 removes the lottery purchase from the CTP proxy basket.

A DBGVoidResponse message 142 is returned back to the POS application 22 from the CTP proxy 40 indicating that the voiding has been successful. The POS application 22 ensures that the lottery purchase is also removed from the POS application basket and the item removal is shown to the POS operator 31 on the display at step 144.

Should an error occur during a lottery transaction, the CTP proxy 40 is arranged to ensure that any incomplete transactions are voided from the CTP 16. In this situation, the CTP proxy 40 automatically initiates a DBGVoid message sequence 140, with the appropriate error codes obtained from the ELF files 82, 84, between the CTP-IL and blocks further interaction from the POS application 22 until the error is cleared and the transaction is cancelled.

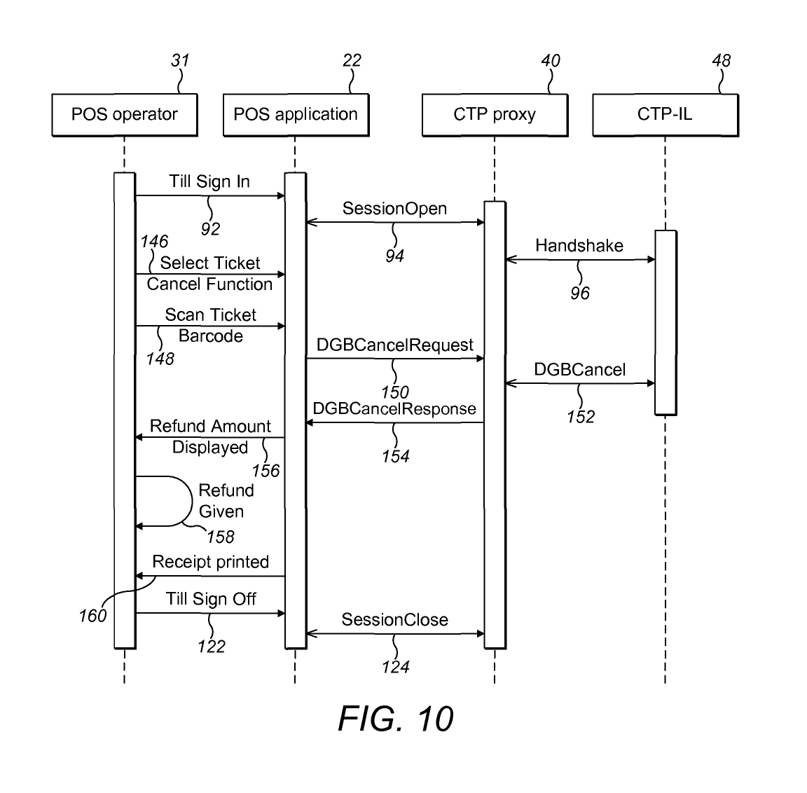

A customer may wish to cancel a lottery ticket that they have purchased before that lottery is drawn. Alternatively, if voiding a ticket fails, a ticket cancellation may be required to refund the customer's money. A method of cancelling a lottery ticket according to the present invention is described with reference to FIG. 10.

Depending on the lottery provider there may be restrictions on when and where a lottery ticket may be cancelled. For example, the cancellation may only be performed on the POS equipment 13 in the supermarket in which the lottery ticket was purchased. The cancellation cannot be performed more than two hours after the ticket was purchased or within the first minute after the ticket is purchased.

The method to cancel a lottery ticket begins with “Till Sign In”, “SessionOpen” and “Handshake” as described above with reference to FIGS. 7a, 8 and 9. At step 146 a customer with a valid lottery ticket selects a ticket cancel function icon on the display 26 of the POS equipment 13. At step 148 a barcode printed on the lottery ticket is scanned by the scanner 20, or in an alternative embodiment a code on the lottery ticket is entered using the input means 30.

Upon receiving the barcode the POS application 22 sends a DBGCancelRequest message 150 to the CTP proxy 40 which includes the details of the lottery ticket. The CTP proxy 40 then compares the lottery ticket with the ELFs 82, 84. If the ELFs 82, 84 confirm that this is a valid ticket and it meets the criteria for cancellation, i.e. the ticket was not purchased within the previous minute or more than two hours ago, a DBGCancel message sequence 152 is initiated.

An initial DBGCancel message is sent in the DBGCancel message sequence 152 to the CTP-IL 48 which contains the details of the ticket and the appropriate error code which is obtained from the EFLs 82, 84. On receipt of the initial DBGCancel message the ticket is marked as cancelled in the CTP 16 and a further DBGCancel message is sent in the DBGCancel message sequence 152 from the CTP-IL 48 to the CTP proxy 40 confirming cancellation of the ticket.

This results in the transmission of a DGBCancelResponse message 154 from the CTP proxy 40 to the POS application 22. The DGBCancelResponse message 154 indicates how much must be refunded to the customer, which is displayed to the customer at step 156 by the display 26. At step 158 the customer is refunded the cost of the ticket. The DGBCancelResponse message 154 also contains XML data associated with a cancellation receipt, which is printed at step 160, after the refund is given to the customer.

While the above embodiments of the invention show only a single lottery transaction making up the entire customer transaction, in practice multiple lottery transactions may be made within the same CTP proxy basket. It may be that other items on sale within the retail location will also be purchased within the same customer session, but the POS application 22 and not the CTP proxy 40 will track these. The CTP proxy 40 will track all lottery transactions within the active CTP proxy basket, and will return a consolidated set of tickets to the POS application 22 during the BasketRoll message sequence 118. The BasketRoll message sequence 118 allows the CTP proxy 40 to understand that the POS application 22 is rolling to a new basket and needs to print out all outstanding items in the current CTP proxy basket.

The POS equipment 13 of a prior art checkout 8, 10, 12 may be modified to provide apparatus according to the invention. In the present embodiment, the CTP proxy 40, the DCC 38 and the proxy asset register 42 are downloaded to and installed on the POS terminal 24 of the prior art checkout 8, 10, 12. The CTP proxy 40, the DCC 38 and the proxy asset register 42 are delivered on electronic media such as a CD or a USB stick, or may be downloaded under the instruction of a set-up file. However, in order to ensure that the CTP proxy 40 is able to provide connectivity to the CTP 16, the CTP proxy 40 is installed on hardware that includes internet protocol (IP) connectivity.

An MCF 70 is also included on the electronic media or downloaded under the instruction of the set-up file. The MCF 70 is used to configure the CTP proxy 40, proxy asset register 42 and DCC 38, if necessary. The MCF 70 contains base implementation files and default directories and structures to facilitate the installation of the invention on the prior art POS equipment 13. The MCF 70 may also provide the option to allow the retailer to tailor the instillation of the invention in accordance with its requirements.

During installation of the CTP proxy 40, DCC 38 and proxy asset register 42 on the POS terminals 24 of the checkouts 8, 10, 12 in a retailer's store, each POS client 18 is assigned a unique identity within the retailer's network. The retailer is therefore able to manage the lottery services offered at each checkout 8, 10, 12 via the head office network 4.

In addition, a unique password is constructed by the CTP 16 for each POS client 18. For each POS client 18 the unique password is further encrypted locally using a compiled hash key and then split for subsequent storage on the POS client 18. Each subsequent request from the POS client 18 will then ‘reconstruct’ the unique password which is forwarded with the unique identity as part of an authorised name pair.

Thereafter, for any request sent by a CTP proxy 40 to the CTP 16, the same encrypted identity key will need to be generated by the POS client 18, and will need to match that already known to the CTP 16 before being allowed to commit any request/response sequence. This protects against unauthorised traffic, operational mode or copying to additional devices.

Once installed on POS equipment 13, the invention advantageously enables the contents of the proxy asset register 42 to be updated, thereby allowing updates to existing lottery games or services and new lottery games or services to be offered on the POS equipment 13. Updates are stored in and downloaded from the CTP 16.

The configuration files 44 and the image data files 46 stored in the proxy asset register 42 and associated with each lottery game or service are controlled and updated by the lottery provider by downloading the appropriate asset updates to the proxy asset register 42. The image data files, which include files for generating the GUI, and the data fields displayed in a play slip and required by the lottery provider are updated through configuration changes and updates initiated by the lottery provider and are centrally distributed via the CTP 16 and managed on the electronic POS equipment 13 by the CTP proxy 40. This has the advantage of enabling new lottery games and other new services to be launched without requiring a change to the POS application 22 software or the POS equipment 13. For example, new games can simply be implemented using a new GUI. The retailer may chose to enable POS operators to invoke specific GUIs from specific buttons or icons displayed on the display 26, or may invoke one screen as the master menu for all lottery functions.

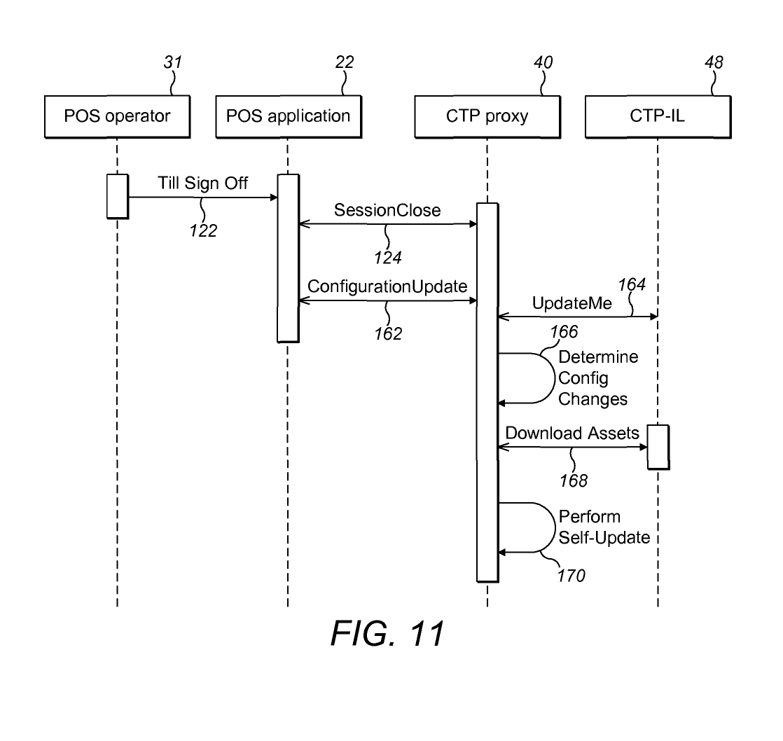

A method of updating the contents of the proxy asset register 42 is now described with reference to FIG. 11. In order to update the proxy asset register 42 the POS equipment 13 must be dormant as indicated in FIG. 11 by the POS operator signing off the POS equipment 13 at step 122 and the SessionClose message sequence 124.

To initiate the update, the POS application 22 initiates a ConfigurationUpdate message sequence 162 with the CTP proxy 40. The ConfigurationUpdate message sequence 162 is initialised every day when the supermarket is closed or at another quiet time such as in the evening, overnight or early in the morning—whenever is convenient for the supermarket retailer. Executing the updating method daily before the next session for a checkout 8, 10, 12 ensures those updates are available the next time the checkout 8, 9, is in use.

On receipt of an initial ConfigurationUpdate message as part of the ConfigurationUpdate message sequence 162, the CTP proxy 40 initiates an UpdateMemessage sequence 164 with the CTP-IL 48. An initial UpdateMe message is sent in the UpdateMemessage sequence 164 from the CTP proxy 40 to the CTP-IL 48 which contains details of the data stored in the proxy asset register 42. For example, the versions and release dates of the configuration files 44 stored in the proxy asset register 42. A response UpdateMe message is sent from the CTP-IL 48 to the CTP proxy 40 which contains details of the lottery products available via the POS equipment 13 at that checkout 8, 10, 12. The contents of the response UpdateMe message are recorded on a master schedule stored in the proxy asset register 42. The CTP proxy 40 then compares the data stored in the proxy asset register 42, namely the configuration files 44 and image data files 46, with those assigned to that checkout 8, 10, 12 as recorded on the master schedule.

If the CTP proxy 40 determines at step 166 that assets held in the proxy asset register 42 require updating, the CTP proxy 40 initiates a download assets message sequence 168. An initial download assets message is sent in the download assets message sequence 166 from the CTP proxy 40 to the CTP-IL 48 requesting the necessary updates. The updates are downloaded from the CTP 16 to the CTP proxy 40 in a further download assets message in a ZIP file.

The updates are extracted from the further download assets message to a temporary folder in the proxy asset register 42. The CTP proxy 40 then updates at step 170 the configuration files 44 and image data files 46 in the proxy asset register 42, as required, for example by modifying, deleting or replacing files. Each piece of data may be iteratively selected and processed.

The POS terminal 24 is then restarted and the new versions and release dates of the configuration files 44 and image data files 46 are recorded ready to be sent to the CTP-IL 48 in the next UpdateMe message sequence 168.

In summary, at the conclusion of the update cycle the CTP proxy 40 will have performed the following steps: review the master schedule; apply any updates to current games that are required; make deletions to the data stored in the proxy asset register 42, as required; and add any data associated with any new games.

The update cycle is performed when POS equipment 13 is in a dormant state to ensure that any new games or updates are available via the checkout 8, 10, 12 on the day of release of that modified or new game or service.

The CTP-IL 48 also monitors messages arriving from the CTP proxy 40 and is able to block out-of-date messages and return one or more appropriate error codes as set out in the ELFs 82, 84. In an emergency the CTP-IL 48 is able to force an immediate update of the games offered at a checkout by downloading to the CTP proxy 40 the updates required at the proxy asset register 42. An example of an emergency could be when a game or service in unexpectedly withdrawn.

Updates may be downloaded ahead of schedule. For example, the data required for a new lottery game may be downloaded several days ahead of the release date of the game. An activation date will be associated with the data associated with that game, at which date that data becomes active. The management of the updating method is controlled by the CTP 16.

The method of updating according to the invention has the benefit of allowing new lottery games or other services to be introduced without modifying the components of prior art POS equipment 13. Rather, further components are added which interact with standard components already installed as standard on the POS equipment 13. For example, new lottery games can be introduced simply by uploading new configuration files to the CTP proxy 40 and DCC 38 component. The effect is that no modification of the POS application 22, or the POS equipment 13 generally, is required.

It will be clear to the skilled person that modifications may be made to the above described systems or methods without departing from the scope of the invention as set out in the following claims.

1.-99. (canceled)

100. An electronic transaction system for managing transactions related to items selected by a user, the system comprising:
a first transaction module arranged to manage transactions in respect of local items supplied within a retail environment;
a data store arranged to store updatable data relating to remote items provided by a remote server; and
a second transaction module arranged to access the updatable data to provide access to the remote items via the electronic transaction system.

101. The electronic transaction system of claim 100, wherein the second transaction module is in communication with the first transaction module.

102. The electronic transaction system of claim 100, wherein the second transaction module comprises a remote server proxy arranged to communicate with the remote server.

103. The electronic transaction system of claim 100, wherein the data in the updatable data store comprises display related data for display to a user in the retail environment in order to allow the selection of a remote item.

104. The electronic transaction system of claim 100, wherein the data in the data store comprises access related data to allow the transaction system and/or the second transaction module to access a remote item for provision to the user in the retail environment.

105. The electronic transaction system of claim 100, wherein the data store comprises display related data and/or access related data that are/is updatable with newer version data.

106. The electronic transaction system of claim 100, wherein the electronic transaction system and/or the second transaction module are/is arranged to download newer version data from a remote data source.

107. The electronic transaction system of claim 106, wherein the remote data source is the remote server.

108. The electronic transaction system of claim 100, wherein the data may be updated with newer version data sideloaded from a data module in the retail environment.

109. The electronic transaction system of claim 100, wherein the data store contains at least one configuration file that defines data associated with one or more remote items.

110. The electronic transaction system of claim 109, wherein the at least one configuration file includes a master configuration file which controls the updating of the data in the data store.

111. The electronic transaction system of claim 110, wherein the master configuration file is not updatable.

112. The electronic transaction system of claim 110, wherein the master configuration file contains parameters relating to the configuration of the second transaction module.

113. The electronic transaction system of claim 110, wherein the master configuration file is stored in the updatable data store.

114. The electronic transaction system of claim 110, wherein the master configuration file is stored in the second transaction module.

115. The electronic transaction system of claim 109, wherein the at least one configuration file includes at least one subordinate configuration file which define parameters associated with one or more remote items, wherein at least one subordinate configuration file is updatable.

116. The electronic transaction system of claim 115, wherein the at least one subordinate configuration file is located on a server remotely located with respect to the electronic interaction system.

117. The electronic transaction system of claim 115, wherein the at least one subordinate configuration file includes at least one communications/protocol file that defines the parameters for communications between elements of the system.

118. The electronic transaction system of claim 115, wherein the at least one subordinate configuration file includes at least one service request control file that defines the structure of messages sent between elements of the system.

119. The electronic transaction system of any of claim 115, wherein the at least one subordinate configuration file includes at least one error file that provides a means of identifying errors and responding accordingly.

120. The electronic transaction system of claim 119, wherein the at least one error file includes a list of error codes and a list of error messages.

121. The electronic transaction system of claim 115, wherein the at least one subordinate configuration file includes at least one pricing file which indicates the price of the remote items.

122. The electronic transaction system of claim 115, wherein the at least one subordinate configuration file includes at least one reference file for accessing information not available in the electronic transaction system.

123. The electronic transaction system of claim 115, wherein the at least one subordinate configuration file includes at least one file arranged to enable one or more subordinate configuration files to be modified using the electronic transaction system.

124. The electronic transaction system of claim 100, wherein the electronic transaction system comprises a data entry module, and the data entry module is arranged to access data stored in the data store.

125. The electronic transaction system of claim 123, wherein the data entry module is located in the electronic transaction system.

126. The electronic transaction system of claim 123, wherein the data entry module is located in the second transaction module and/or on a server remotely located with respect to the electronic transaction system.

127. The electronic transaction system of claim 123, wherein the electronic transaction system comprises a display, and the data entry module is arranged to display a GUI on the display.

128. The electronic transaction system of claim 127, wherein the display is arranged to display details of the local items and/or the remote items.

129. The electronic transaction system of claim 123, wherein the data entry module is arranged to read a code from a code carrying device.

130. The electronic transaction system of claim 100, wherein the electronic transaction system comprises input means which may be a touch-screen display.

131. The electronic transaction system of claim 100, wherein the electronic transaction system comprises a printer for printing information relating to the local items and/or the remote items.

132. The electronic transaction system of claim 100, wherein the electronic transaction system is linked to a local server which comprises or is linked to a local item database which stores details associated with the local items.

133. The electronic transaction system of claim 100, wherein the second transaction module is arranged to generate an initial update message, and send the initial update message to the remote server in order to update the data stored in the data store; and/or the second transaction module is arranged to generate a remote item request message using data stored in the updatable data store, and send the remote item request message to the remote server; and/or the second transaction module is arranged to receive a response update message in order to update the data stored in the data store; and/or the second transaction module is arranged to receive a remote item or remote item data from the remote server.

134. The electronic transaction system according to claim 100 and a remote server, wherein the remote server is a depository for the remote items, or is arranged to generate remote items, and is arranged to deliver one or more remote items to the electronic transaction system.

135. The electronic transaction system according to claim 134, wherein the remote server is linked to the electronic transaction system via a remote server gateway arranged to distribute the remote items to one or more electronic transaction systems.

136. The electronic transaction system according to claim 134, wherein the electronic transaction system and the remote server comprises one or more communication networks linking one or more of the components of the combination.

137. A method of updating a transaction module for managing transactions of remote items obtained from a remote server, wherein the remote items are supplied via an electronic transaction system, the method comprising:
sending an initial update message from the transaction module to the remote server, wherein the update message contains details of data stored in an data store;
comparing the details of the data stored in the data store with a data record indicating the remote items available via the electronic transaction system, and determining if the contents of the data store require updating; and
downloading data from the remote server which comprise updates for the data store.

138. The method of claim 137, the method further comprising receiving the data record from the remote server in a response update message.

139. The method of claim 137, wherein the downloading step comprises sending an initial download message from the transaction module to the remote server, wherein the initial download message contains details of the updates required by the data store; and receiving a response download message from the remote server, wherein the response download message contains the updates.

140. The method of claim 137, wherein the updates comprise configuration file updates and/or image data file updates.

141. The method of claim 137, wherein the method comprises updating the data stored in the updatable data store.

142. The method of claim 137, wherein the details of the response update message are recorded on a master schedule.

143. The method of claim 137, wherein the data store contains details of remote items obtainable from the remote server.

144. The method of claim 137, wherein the method commences when the electronic transaction system is in a dormant state.

145. The method of claim 137, wherein the method further comprises reinitialising the transaction module.

146. A method of performing a transaction in which a remote item is obtained from a remote server via an electronic transaction system, the method comprising:
selecting a class of remote item from one or more classes of remote items;
reading data associated with the selected class of remote item, wherein the data is stored in a data store;
entering input data relating to one or more variables associated with the selected class of remote item into a data input means;
sending the input data to the remote server in a remote item data message;
receiving a remote item acknowledgement message from the remote server containing transaction data confirming that the remote item has been obtained.

147. The method of claim 146, wherein the input data required by the method is defined by the data associated with the selected class of remote item.

148. The method of claim 146, wherein the item acknowledgement message contains the remote item.

149. The method of claim 146, wherein the remote item data message is constructed by the data input means.

150. The method of claim 146, wherein the remote item data message is transmitted from a remote server proxy to the remote server.

151. The method of claim 146, wherein the method comprises validating the remote item data message at the remote server, and the remote server provides a remote item relating to the remote item data message in the remote item acknowledgement message.

152. The method of claim 146, wherein the electronic transaction system comprises a local transaction module, wherein the sending step comprises sending the remote item data message from the local transaction module to the transaction module.

153. The method of claim 152, wherein the method further comprises adding the remote item to transaction data of local items stored in the local transaction module.
